(19) United States
(12) Patent Application Publication
(10) Pub. No.: US 2007/0065570 A1
(43) Pub. Date: Mar. 22, 2007

(54) Method of producing a substrate having areas of different hydrophilicity and/or oleophilicity on the same surface

(75) Inventors: Thomas Kugler, Cambridge (GB); Shunpu Li, Cambridge (GB); Christopher Newsome, Cambridge (GB); David Russell, Cambridge (GB)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/517,443

(22) Filed: Sep. 8, 2006

(30) Foreign Application Priority Data
Sep. 20, 2005 (GB) 0519186.1

(51) Int. Cl. B05D 5/12; B05D 1/12; B05D 5/00

(52) U.S. Cl. 427/58; 427/256; 427/180

(57) ABSTRACT

The present invention relates to substrates having wetting contrasts wherein the surface area of at least one part of the wetting contrast is rough because it is derived from a surface polymer layer comprising particles embedded therein. This surface roughening is important because it affects the surface properties of the substrate, and in particular the hydrophilicity and/or oleophilicity of the surface. According to a first method of the present invention, a substrate having a surface which comprises adjacent areas of different hydrophilicity and/or oleophilicity is produced. The method comprises forming a pattern of a first composition comprising a polymer matrix and particles of a material other than the polymer matrix on a substrate precursor. The present invention further relates to a method of producing a microelectronic component which involves depositing an electronically functional material onto a substrate having a wetting contrast.

### FIELD OF INVENTION

The present invention relates to a method of producing a substrate having areas of different hydrophilicity and/or oleophilicity on the same surface. Such substrates have a use for example in the field of solution processing to form microelectronic devices.

### TECHNICAL BACKGROUND

Electronically functional materials such as conductors, semiconductors and insulators have many applications in modern technology. In particular, these materials are useful in the production of microelectronic components such as transistors (e.g. thin film transistors (TFTs)) and diodes (e.g. light emitting diodes (LEDs)). Inorganic materials such as elemental copper, elemental silicon, and silicon dioxide have traditionally been employed in the production of these microelectronic components, whereby they are deposited using physical vapour deposition (PVD) or chemical vapour deposition (CVD) methods. Recently, newly developed materials and material formulations with conducting, semiconducting or insulating properties have become available and are being adopted in the microelectronic industry.

One such class of electronically functional materials is that of organic semiconductor materials. Another class is that of inorganic metal colloid formulations dispersed in liquid solvents. While the first example is a recently developed class of materials, the second example uses traditional materials in a recently developed formulation type. These materials and material formulations are associated with a number of advantages over the traditional materials when used for microelectronic device production. One such advantage is that these materials can be processed in a greater variety of ways, including for example solution processing where the material is dissolved in a solvent or dispersed as a colloid, and the resulting solution is used to manufacture e.g. microelectronic components. This is advantageous because solution processing is very cost-effective. In particular, a significant saving can be made in terms of start-up costs associated with setting up plants for producing microelectronic components when compared with e.g. silicon semiconductor processing facilities where there is a need for high capital investment in expensive production facilities.

One particularly promising technique for the processing of semiconductors to form microelectronic components, for example TFTs and LEDs, is ink-jet printing. This is because ink-jet printing conveniently allows relatively precise deposition of a semiconductor solution onto a substrate in an automated manner. It would be highly desirable to be able to produce microelectronic semiconductor components on an industrial scale by ink-jet printing conductor, semiconductor and insulator solutions onto a suitable substrate.

However, there are fundamental problems in carrying this out in practice. The key problem is that, in the production of microelectronic devices, it is generally necessary to produce high-resolution patterns of the electronically functional materials on a substrate. At present, ink-jet printing does not allow a high enough resolution to be achieved to allow the direct printing of suitable patterns onto a bare substrate. At present, there are two ways to avoid this problem.

The first way is to use photolithography to remove undesired areas of a blanket-deposited electronically functional material, very high-resolution patterns being obtainable by this method. However, photolithography is a subtractive technology and is expensive both in terms of initial investment in expensive photolithographic equipment and in terms of the relatively large number of processing steps associated with these techniques, energy consumption and wasted material.

A second way of circumventing the resolution problems associated with ink-jet printing of patterns of electronically functional materials on bare substrates is to form a pre-pattern on the substrate prior to deposition of the electronically functional material thereon which directs the inkjet-printed solution onto specific areas. Generally, this involves treating the substrate to form a wetting contrast consisting of adjacent areas on the surface having different hydrophilicity and/or oleophilicity to ensure different interaction with electronically functional inks subsequently printed thereon. Thus a substrate can be produced having ink-receptive areas and ink-repellent areas, so that a droplet of ink landing on an ink-receptive area of the substrate would be prevented from spreading onto the adjacent ink repellent area. Similarly, any droplet of ink landing so that it contacts both the ink-receptive and ink-repellent areas would be pushed towards the ink-receptive area. In this way, the resolution of an ink-jet printer can be enhanced to allow the required resolution to produce patterning as required in the production of microelectronic devices. For this to work effectively, the difference in hydrophilicity and/or oleophilicity between the two areas of the substrate should be as large as possible.

At present, this latter technique requiring the establishment of adjacent ink-receptive areas and ink-repellent areas on a substrate has only been realised on inorganic substrates such as indium tin oxide or silicon oxide (glass) plates. Where such a substrate is used, it is conventional to apply a photo-crosslinkable polymer (=negative resist) coating (for example polyimide) to an inorganic oxide plate and then selectively dissolve those parts of the polymer coating that were protected by a photomask against the UV-irradiation during a crosslinking step to reveal the underlying inorganic oxide. Subsequent treatment of the entire substrate with e.g. a CF₄ plasma leaves the exposed inorganic oxide substrate hydrophilic but renders the polymer surface hydrophobic and oleophobic thus establishing a wetting contrast. Subsequent printing of an aqueous conductor ink onto the exposed glass parts allows a high resolution pattern to be formed even if the patterning carried out is required to be of higher resolution than the ink-jet printing because droplets of aqueous ink falling in part on the hydrophobic and oleophobic polymer area will be pushed on to the hydrophilic glass area.

Whilst this method of creating adjacent ink-receptive and ink-repellent areas on the substrate is generally quite effective in increasing the resolution obtainable when ink-jet printing a solution of an electronically functional material, several problems are associated with these techniques so that there is a need for the development of new techniques which allow substrates with wetting contrasts to be produced.

The main problem with the existing substrates is that it is difficult to produce substrates having wetting contrasts having a high enough difference in hydrophilicity and/or oleophilicity between the adjacent areas making up the wetting contrast. At present, when using the conventional techniques making use of a glass plate and a polyimide, a wetting contrast would usually have to be produced by fluorinating the entire surface of the glass and polyimide substrate after having carried out the dissolving step to pattern-wise reveal the glass plate underlying the polyimide in order to produce a wetting contrast having a large enough difference in hydrophilicity and/or oleophilicity between the adjacent areas which make up the wetting contrast. The fluorination treatment fluorinates the polyimide surface rendering it hydrophobic and oleophobic, and increases the hydrophilicity of the exposed glass areas, thus creating the desired wetting contrast.

However, this practice is not always suitable for preparing an appropriate substrate for ink-jet printing electronically functional materials.

Firstly, whilst the above method can be used to produce reasonably good wetting contrasts which are generally acceptable in terms of their ink-directing properties, there is still room for improvement in this area so that there is still a need for the development of new substrates having wetting contrasts where the difference in hydrophilicity and/or oleophilicity between the adjacent areas which make up the wetting contrast is even higher.

Secondly, it is a problem with the known methods that appropriate wetting contrasts can only be realised by including a step of surface-fluorination. It would be highly desirable to be able to produce a substrate having an appropriate wetting contrast without the need to carry out any fluorination step. This is because, for certain applications, it is undesirable to have fluorinated surface groups on the substrate, e.g. where the substrate has electronically functional inks deposited thereon. This is firstly because problems may arise where the fluorinated groups are in direct contact with a semiconducting polymer because the strong dipole moments associated with C—F bonds may result in the accumulation of holes at the interface between a P-type semiconducting polymer and the substrate; this may alter the electronic properties of the semiconductor by for example increasing the off-current which is undesirable. Secondly, fluorinated surfaces famously have very low surface energies so that most substances will adhere relatively poorly to a fluorinated surface. One consequence of this is that where fluorinated surfaces are used as a substrate for ink-jet printing of e.g. micro-electronic devices, mechanical failure of the device is more likely than in similar devices produced using non-fluorinated substrates.

Thirdly, the current techniques typically use plasma treatment of the substrate to achieve the appropriate wetting contrasts, plasma treatment with for example CF₄ or O₂ plasma reacting differently with the two adjacent areas to increase the difference in hydrophilicity and/or oleophilicity. However, in practice such plasma treatment is not preferably especially in large-scale production. This is because plasma treatment can only be effected in a vacuum chamber which is not easily incorporated into a standard production line.

An additional problem with the known substrates is that they all rely on rigid substrates such as glass or indium tin oxide. Such substrates are all rigid and cannot therefore be used in reel-to-reel processing, a technique whereby a roll of unprocessed substrate is unreeled, processed and the processed substrate collected on a second reel. Such processing is most desirable to use in practice and therefore it would be a significant improvement if it were possible to solve the above problems and at the same time produce substrates which are flexible enough to allow such processing.

Accordingly, there is still a need for novel techniques of preparing substrates having wetting contrasts which allow a variety of substrates with good wetting contrasts to be produced. Specifically, there is a need to develop substrates having good wetting contrasts without the need for surface fluorination and potentially also for improving on the known fluorinated substrates to achieve even higher differences in hydrophilicity and/or oleophilicity between the areas making up the wetting contrast.

With a view to solving the above-mentioned technical problems, the present inventors set out to provide a new method of producing substrates having appropriate wetting contrasts with a view to overcoming the deficiencies of the known methods.

### BRIEF DESCRIPTION OF THE PRESENT INVENTION

According to a first aspect of the present invention, there is provided a method of producing a substrate having a surface which comprises adjacent areas of different hydrophilicity and/or oleophilicity, the method comprising:

(ia) forming a pattern of a first composition comprising a polymer matrix and particles of a material other than the polymer matrix on a substrate precursor.

According to a second aspect of the present invention, there is provided a method of producing a substrate having a surface which comprises adjacent areas of different hydrophilicity and/or oleophilicity, the method comprising:

(ib) coating a substrate precursor with a first composition comprising a polymer matrix and particles of a material other than the polymer matrix on a substrate precursor; and

(ic) forming on the first composition a pattern of a second composition comprising a polymer, the second composition having a different hydrophilicity and/or oleophilicity to the first composition.

According to a third aspect of the present invention, there is provided a method of producing a modified substrate having a surface which comprises adjacent areas of different hydrophilicity and/or oleophilicity, the method comprising the steps of:

(i) producing a substrate by any method defined above; and

(ii) chemically treating the substrate surface to form the modified substrate, the adjacent surface areas of the modified substrate having a greater difference in hydrophilicity and/or oleophilicity than the corresponding areas of the substrate prior to chemical treatment.

According to a fourth aspect of the present invention, there is provided a method of producing a microelectronic component, comprising the steps of:

(i) producing a substrate or modified substrate having adjacent areas of different hydrophilicity and/or oleophilicity on the same surface by any method defined above; and

(ii) depositing a first solution onto the substrate or modified substrate to form an area comprising a first electronically functional material.

According to a fifth aspect of the present invention, there is provided a substrate having adjacent areas of different hydrophilicity and/or oleophilicity on the same surface, one of the adjacent areas corresponding to an area comprising a surface layer comprising particles in a polymer matrix.

### DETAILED DESCRIPTION OF THE PRESENT INVENTION

The present inventors have investigated possible ways of producing a substrate on which it is possible to produce improved wetting contrasts, and in particular possible ways of producing such substrates which ideally use only a small number of process steps, avoid the need for plasma treatment, avoid the need for surface fluorination and which allow flexible substrates to be used (although it is not strictly necessary for the methods to meet all of these requirements).

The present inventors have found that these goals can be achieved by producing substrates wherein at least one of the adjacent areas making up the wetting contrast has a rough surface. The roughening may be due to the substrate being formed by the deposition of a first composition which comprises a polymer matrix and inorganic particles on a substrate precursor, the particles being present immediately under the surface of the dried layer of the first composition to form a rough surface. The substrates thus produced are particularly useful in the manufacture of microelectronic devices.

Alternatively, useful substrates can be produced by depositing on a substrate precursor a composition comprising a polymer matrix, said composition allowing the formation of particles in situ on the substrate after deposition. The person skilled in the art would appreciate several ways in which this could be achieved. For example, where it is desired to deposit inorganic particles on the surface of the substrate in order to achieve surface roughening, a compound of the formula Si (OR)₄ may be added to the polymer (R being a C₁-C₆ alkyl group). When exposed to water, for example in the form of water vapour in the atmosphere, such silicon compounds form discrete SiO₂ particles which lead to surface roughening. Alternatively, particles could be formed in situ by adding to a composition comprising a polymer and a solvent a soluble organic small molecule which is soluble in the solvent and then depositing the composition on a precursor to allow the formation of crystals on drying. The term “small molecules” encompasses organic molecules having a molecular weight in the range 50-5000, preferably 200-1000, most preferably 200-800. An example of such a small molecule is dihexylquarterthiophene (DH4T) which is soluble in organic solvents such as toluene, mesitylene or difluorobenzene and which forms crystals on drying. Further Examples of small molecules which could be used include biphenyl, terphenyl, naphthalene and anthracene.

The advantage of forming the particles which give rise to the roughened surface in situ is that this allows convenient deposition of the composition using ink-jet printing. This is because it is generally not desirable to ink-jet print inks which comprise large, micron-sized (75 microns) particles because these tend to clog the printer heads.

The main advantage of using substrates which have one of the above-described constructions arises because the roughness resulting from the inclusion of the particles affects the surface properties of the substrate. Specifically, this roughness increases a substrate's philicity or phobicity to particular solvents. Thus, roughening a surface renders a hydrophilic surface more hydrophilic, a hydrophobic surface more hydrophobic, an oleophilic surface more oleophilic, and an oleophobic surface more oleophobic.

The use of a first composition comprising a polymer and particles to achieve this roughening is advantageous over other roughening techniques mainly because it can be achieved with no extra processing steps relative to the known techniques where smooth polymer surfaces are deposited. Thus the only change in the existing methods would be to exchange the usual polymer materials for a composition which allows formation of particles on or below the substrate surface.

Furthermore, the methods of the present invention can be used in new ways, for example in producing flexible substrates which have appropriate wetting contrasts. Furthermore, using these methods substrates having good wetting contrasts can be produced without the need for fluorination or plasma treatment; this is advantageous because, as discussed above, these processing steps are preferably avoided in certain circumstances.

Wetting contrasts consist of areas of differing hydrophilicity and/or oleophilicity. For the purposes of this invention, hydrophilicity of a surface is measured via its contact angle with water, whilst oleophilicity is measured via contact angles with hexane, that is the angle between a given surface and a droplet of a designated amount of the relevant liquid. Such contact angle measurements are well-known in the art, and measurements can be made using e.g. a goniometer (contact angle measuring device) to measure droplets of 1-5 μl on a surface of interest. Preferably, the wetting contrast in the substrates of the present invention have adjacent surface areas whose contact angles with water and/or hexane differ by more than 60°, preferably more than 80° and most preferably more than 100°.

For the purposes of the present invention, the word “hydrophilic” is used to describe surfaces having a contact angle with water of less than 60°. The phrase “very hydrophilic” is used to describe surfaces having a contact angle with water of less than 20°. The phrase “super-hydrophilic” is used to describe surfaces having a contact angle with water of less than 5°.

The word “hydrophobic” is used to describe surfaces having a contact angle with water of more than 60°. The phrase “very hydrophobic” is used to describe surfaces having a contact angle with water of more than 90°. The phrase “super-hydrophobic” is used to describe surfaces having a contact angle with water of more than 120°.

The word “oleophilic” is used to describe surfaces having a contact angle with hexane of less than 60°. The phrase “very oleophilic” is used to describe surfaces having a contact angle with hexane of less than 20°. The phrase “super-oleophilic” is used to describe surfaces having a contact angle with hexane of less than 5°. The word “oleophobic” is used to describe surfaces having a contact angle with hexane of more than 60°. The phrase “very oleophobic” is used to describe surfaces having a contact angle with hexane of more than 90°. The phrase “super-oleophobic” is used to describe surfaces having a contact angle with hexane of more than 120°.

Table 1 below sets out the hydrophilicities and/or oleophilicities of various substances which may be used in producing the wetting contrasts of the substrates of the present invention. Table 1 also indicates the change in hydrophilicity and/or oleophilicity achievable by various chemical treatments of these substances.

TABLE 1

| | | | | Fluoroalkyl- |
|---|---|---|---|---|
| | No | CF₄ plasma | O₂ plasma | silane |
| | treatment | treatment | treatment | treatment |
| SiO₂ | Hydrophilic | Super- | Super- | Very (for |
| | | Hydrophilic | Hydrophilic | smooth SiO₂ |
| | | | | surfaces) or |
| | | | | Super- |
| | | | | Hydrophobic |
| | | | | (rough SiO₂ |
| | | | | surfaces) |
| | | | | & Oleophobic |
| Polymethyl- | Hydrophobic | Hydrophobic | Very | — |
| methacrylate | & | & | Hydrophilic | |
| (PMMA) | Oleophilic | Oleophobic | | |

In the following paragraphs, possible substrate precursors, polymer matrix materials, particulate materials, polymer materials, coating techniques and chemical treatment methods to produce various wetting contrasts will be explained in more detail. Furthermore, the use of the substrates in producing microelectronic components is discussed. Then, specific embodiments of the present invention will be described with reference to the drawings, in which:

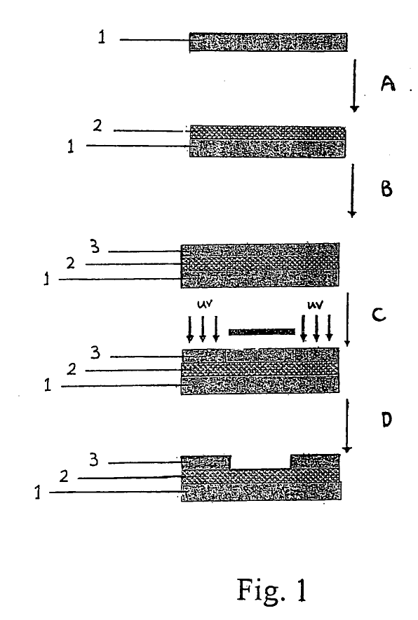

FIG. 1. schematically depicts a first method of realising the method of the present invention;

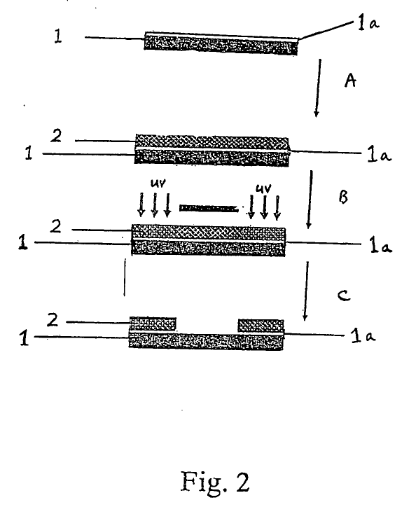

FIG. 2. schematically depicts a second method of realising the method of the present invention; and

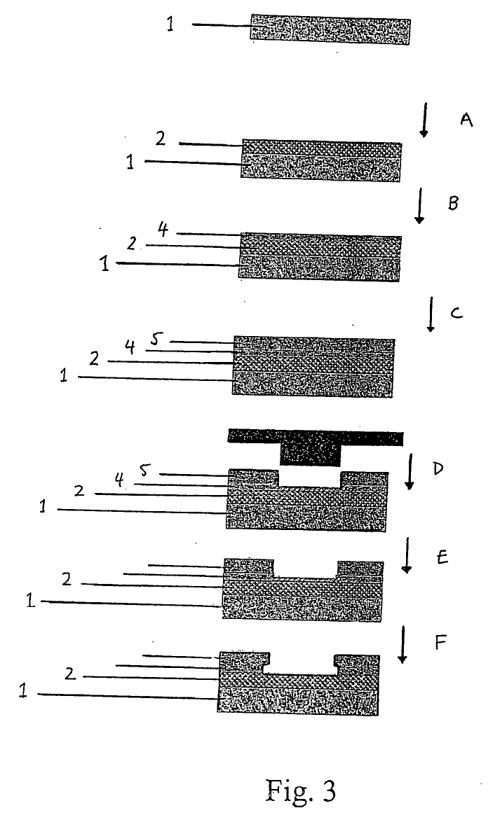

FIG. 3. schematically depicts a third method of realising the method of the present invention.

Substrate and Substrate Precursor

In the present invention, the substrate is a product having a wetting contrast (i.e. two adjacent surface areas which have different hydrophilicities and/or oleophilicities).

In the context of the present invention, the term “substrate” is not limited to the actual substrate used for instance in the production of a semiconductor element. Rather, “substrate” in this context is intended to encompass any material on which a further element, e.g. an electronically functional element, is formed which includes surfaces already coated and/or patterned with e.g. conductors, semiconductors or insulators as intermediate products in the fabrication of e.g. electronic devices such as transistors.

The substrate precursor used in the methods of the present invention is not particularly limited and refers to a material which can be processed to form a substrate. Where the entire surface of the substrate precursor is coated with a mixture of the polymer matrix and the particles so that the substrate precursor remains covered in the substrate product, the nature of the substrate precursor is unimportant as it does not form part of the wetting contrast. In such cases, only the physical properties of the substrate precursor are important.

In view of the desirability of using the substrate obtainable by the methods of the present invention in the production of microelectronic components, in particular using reel-to-reel processing, it is preferable if the substrate itself and the substrate precursor are flexible. Preferably, the substrate and the substrate precursor are flexible to the extent that they are rollable so that a roll having a diameter of 10 meters or less can be formed. More preferably, it is possible to roll the substrate and the substrate precursor to form a roll having a diameter of 5 meters or less, even more preferably 2 meters or less and most preferably 1 metre or less.

Where the substrate precursor surface forms part of the wetting contrast of the substrate, its hydrophilicity and/or oleophilicity is important. Furthermore, its chemical properties may be important if it is desired to further treat the surface of the precursor to increase the difference in hydrophilicity and/or oleophilicity.

Thus, it is possible to use a conventional glass or indium tin oxide plate if desired. This advantageously allows the use of conventional chemical treatment methods to increase the difference in hydrophilicity and/or oleophilicity between the adjacent areas making up the wetting contrast.

Alternatively, the substrate precursor may be formed from a flexible polymer having a hydrophilicity and/or oleophilicity different to the polymer present in the polymer matrix. This advantageously allows a flexible substrate to be produced, which is desired where it is intended to use the substrate in reel-to-reel processing and is preferably used where substrate precursor does not form part of the wetting contrast of the substrate. However, a polymer substrate precursor may also be used where the precursor does form part of the wetting contrast of the substrate, especially where it is preferable not to make use of the chemical properties of an inorganic oxide surface, i.e. where fluorination is not desired and where plasma treatment is not desired.

Specific examples of substrate precursors which can be used in the methods of the present invention include metal foils (e.g. aluminium or steel) and polymer foils produced from polyimide (PI), polyethylene terephthalate (PET), polyethylene naphthalate (PEN), polycarbonate (PC), polynorbornene (PNB) and polyethersulfone (PES).

Where it is desired to use a hydrophilic substrate precursor, foils made from or coated with e.g. a thin metal layer (e.g. aluminium or steel), regenerated celluloses, polyvinyl alcohol, polyvinylphenol (PVP) or polyvinylpyrrolidone can be used.

Where it is desired to use a hydrophobic substrate precursor, polymers such as polyimide (PI), polyethylene terephthalate (PET), polyethylene naphthalate (PEN), polycarbonate (PC), polynorbornene (PNB) and polyethersulfone (PES) can be used.

Specific examples of inorganic substrate precursors which can be used in the methods of the present invention include glass plates, indium tin oxide plates and any other material or material combination that can be surface-oxidised by exposure to oxygen plasma.

Polymer Materials Used in the First Composition

In the present invention, it is in principle possible to use any polymer as the polymer matrix material in the first composition. The polymer matrix material should be selected appropriately in view of the material used to create the other part of the wetting contrast (i.e. either the material of the substrate precursor or the second composition deposited on to the composition comprising the matrix polymer and the particles). Specifically, a combination of materials which gives rise to a large difference in hydrophilicity and/or oleophilicity should be selected.

Preferably, polymers already used in the field of preparing substrates for use in the preparation of microelectronic components should be used as the polymer matrix material in view of the fact that skilled workers are already familiar with such materials. Currently used materials include polyimides (PI), benzocyclobutene (BCB), epoxy-based negative resists (e.g. SU-8), photo-initiated curing acrylates (e.g. Delo-photobond), polyacrylates (e.g. polymethylmethacrylate (PMMA)), polymethylglutarimide (PMGI) and polyvinylphenol.

Where one of the areas of the substrate making up the wetting contrast is an inorganic oxide, the adjacent area may for example be a polymer such as a polyimide (PI), benzocyclobutene (BCB), epoxy-based negative resists (e.g. SU-8), photo-initiated curing acrylates (e.g. Delo-photobond), polyacrylates (e.g. polymethylmethacrylate (PMMA)), polymethylglutarimide (PMGI) or polyvinylphenol.

Alternatively, both of the adjacent areas may be polymer materials, one of which would be the polymer matrix in the first composition. Examples of pairings of polymer materials which give rise to appropriate wetting contrasts include:
PMMA and polyvinylphenol (PVP);
PMGI and polyvinyl alcohol; and
BCB and polyvinylpyrrolidone.
   The first composition preferably comprises a solvent (e.g. butylacetate).
   Particulate Materials Used in the First Composition

In the present invention, it is in principle possible to use any particulate material provided that it results in an increased roughness of the surface of the substrate coated with a mixture of the polymer matrix and the particles relative to a substrate coated with the polymer matrix material alone. As explained above, the particles may be present in a composition which is deposited on a substrate precursor, or may be formed only after deposition (i.e. formed in situ).

Relative surface area can for example be measured by a technique such as Atomic Force Microscopy (AFM), using equipments such as the Dimension 3100 Scanning Probe Microscope as supplied by Veeco.

In terms of the composition of the mixture of the solvent, the polymer matrix and the particles to make up the first composition, the particles are preferably contained in this first composition in an amount of 10-70 vol. %, more preferably 20-60 vol. % and most preferably 30-40 vol. % relative to the total amount of polymer and inorganic particles. It is generally important to agitate the mixture appropriately to ensure proper dispersion of the particles throughout the composition and avoid excessive clumping together of the particles. It is possible to ensure appropriate mixing of the first composition by stirring the mixture, for example by means of mechanical stirring and/or ultrasonic stirring.

The identity of the particles is not critical. However, it is preferable to use inorganic particles, preferably inorganic oxide particles, in view of the fact that where these particles are used, it is possible to etch away part of the polymer matrix in an area where the first composition is deposited to reveal the underlying particles (e.g. by plasma etching). This may be advantageous where it is desired to further treat the substrate chemically to increase the difference in hydrophilicity and/or oleophilicity because this would allow the use of known techniques to create wetting contrasts between polymer and glass areas e.g. fluorination and plasma treatments, especially where it is desired to use a flexible substrate.

Where an inorganic oxide is used, it is in principle possible to use any inorganic oxide. For the purposes of the present invention, the term “inorganic oxide” is taken to encompass non-organic materials which are solid at room temperature and at ambient pressure and which have an oxygen atom. Thus minerals containing oxygen atoms are for the purposes of the present invention classed as inorganic oxides, as are the solid oxides of metals (e.g. aluminium and titanium) and the solid oxides of semi-metals (e.g. silicon). Inorganic oxides which can be used include binary oxides (such as silicon dioxide (SiO₂), aluminium oxide (Al₂O₃), titanium dioxide (TiO₂), tin oxide (SnO₂) and tantalum pentoxide (Ta₂O₅)), ternary oxides (such as indium tin oxide (ITO) and perovskites (e.g. CaTiO₃ or BaTiO₃)) and quaternary oxides such as zeolites (Mⁿ⁺_{x/n}[(AlO₂)ₓ(SiO₂)_{y}].MH₂O).

Furthermore, in addition to the above-mentioned inorganic oxides, any material or material combination that turns hydrophilic upon exposure to O₂ plasma and/or CF₄ plasma (by initial formation of a fluorine terminated surface that reacts with water to form a hydroxy-terminated surface) may be used. Specific examples include elemental metals or semiconductors such as aluminium, tin, titanium, aluminium-copper alloys, silicon and germanium; metal chalcogenides such as tin sulphide and tungsten selenide; metal nitrides such as boron nitride, aluminium nitride, silicon nitride and titanium nitride; metal. phosphides such as indium phosphide; carbides such as tungsten carbide or silicon carbide; and metal silicides such as copper silicide.

As examples of particles that result in an increased surface roughness but do not turn hydrophilic upon exposure to CF₄ plasma, Carbon black polymers cellulose, gold, silver and copper powders are mentioned.

As for the size of the particles used to mix with the polymer matrix to make up the first composition, these preferably have an average particle size as measured by Transmission Electron Microscopy (TEM) of less than 5 μm, more preferably less than 0.5 μm, most preferably less than 0.05 μm. The particles are preferably nanoparticles having an average size in the range 5-1000 nm, more preferably 5-100 nm, most preferably 10-20 mm. Such small particles are preferable for a number of reasons.

Firstly, small particles result in better optical quality of the resulting substrates. For particle sizes smaller than the wavelength of the visible light, light scattering is avoided and a clear particle-polymer composite film can be obtained. This is important where the substrate is used in display applications.

Secondly, small particles result in an appropriate roughness of the surface layer. Nanoparticles are preferable to micron-sized particles, as the latter result in a surface roughness of the composite film on a scale corresponding to the particle sizes. Although it is generally preferable for a substrate to have a rough surface, there is a limit to how rough a surface can be and still allow appropriate end products (e.g. microelectronic components) to be produced. Substrates for microelectronic applications should have a surface roughness below the required pattern sizes. Therefore, the use of nanoparticles allows the surface area of the substrate surface to be increased without roughening the surface to the extent that further processing becomes difficult.

Thirdly, small particles are preferably used in view of the chemical homogeneity of the substrate. In order to achieve high-resolution patterning by inkjet printing, the lateral variations in the surface composition, which result in a corresponding variation of the surface energy, should preferably be on a scale smaller than the required pattern sizes.

Polymer Materials Used in the Second Composition

Where a second composition comprising a polymer is deposited onto the first composition comprising the polymer matrix and the particles, there is no particular restriction on the polymer used. Again, where the polymer will constitute one of the adjacent areas making up the wetting contrast, it is important to select an appropriate polymer having a wetting contrast different to that of the first composition.

The polymers used in the first and second compositions should be selected as a pair of polymers which differ in hydrophilicity and/or oleophilicity. Examples of pairings of polymer materials which can be used to produce appropriate wetting contrasts include PMMA and polyvinylphenol (PVP);
PMGI and polyvinyl alcohol; and
BCB and polyvinylpyrrolidone.

Advantageously, the second composition may comprise particles to also increase the surface area where the second polymer is deposited. Reference is made to the above discussion of preparing and applying the first composition, the comments applying equally to the second composition. The polymer comprised in the second composition must be selected to be different from the polymer in the first composition; otherwise no wetting contrast will be produced.

The second composition preferably comprises a solvent (e.g. butylacetate).

Coating Techniques for Applying the First and/or the Second Composition

Where the entirety of the substrate precursor is coated with the first composition comprising the polymer matrix, the particles and a solvent, coating can be achieved for example by spin-coating or doctor-blading the first composition onto the substrate precursor. The thickness of the first composition which is applied is not of critical importance. Nevertheless, it is preferable that the coating is applied in a thickness of 0.5-20 μm, more preferably 1-10 μm, most preferably 1-5 μm and e.g. 2 μm.

Where only part of the substrate precursor is to be coated with the first composition, known techniques for applying a polymer solution to only part of a substrate precursor may be used. For example, a crosslinkable polymer such as polyvinylphenol (PVP) can be used as the polymer matrix, together with a UV crosslinker consisting of (i) a di- or polyfunctional organometallic material containing functional groups capable of reacting with amino groups, wherein said organometallic material is selected from the group consisting of organosilicon, organotin and organogermanium and mixtures thereof; (ii) an amino polymer having available reactive amino groups in a crosslinking effective amount, and (ii) a cationic photocatalyst in an amount effective to initiate crosslinking of said poly(p-vinylphenol), such UV crosslinkers being described in EP0534204. Thus it would be possible to selectively expose to UV light only the areas where it is intended to keep the first composition, for example by using a mask, and then wash away the non-irradiated areas. This technique can equally be used for the selective deposition of the second composition (see Methods 1 and 2 below).

Other techniques which achieve the same result are available, and are known to those skilled in the art and will not be explained in further detail here. An example of a further method which may be used for selective deposition is that used in Method 3 below, which makes use of acid to remove parts of the second composition in a stamped region, the stamping uncovering an acid-sensitive layer adjacent to the layer of the first composition, the unstamped regions having an acid-resistant material at the surface and thus remaining unaffected.

Producing Substrates having Hydrophilic vs. Hydrophobic and Oleophilic Wetting Contrasts

The present invention provides several specific ways in which substrates having hydrophilic vs. hydrophobic and oleophilic wetting contrasts can be produced.

According to a first method depicted schematically in FIG. 1, a substrate having hydrophilic vs. hydrophobic and oleophilic wetting contrasts is prepared by coating a substrate precursor (1) (e.g. a polyimide (PI), polyethylene terephthalate (PET), polyethylene naphthalate (PEN), polycarbonate (PC), polynorbornene (PNB) or polyethersulfone (PES) sheet with e.g. a thickness of 100-150 μm and A4 (210×297 mm) dimensions) with a first composition (2) comprising a polymer (e.g. polymethylmethacrylate (PMMA)), particles (e.g. SiO₂ nanoparticles of average particle size 10-20 nm) and a solvent (e.g. butylacetate) (Step A). The particles may for example be present in the first composition (2) in an amount of 50 vol. % relative to the total amount of polymer and inorganic particles. For example, a 1 μm thick layer of the first composition (2) could be applied to the substrate precursor by spin-coating or doctor-blading. The coated substrate precursor is then left to dry, resulting in a hydrophobic and oleophilic surface.

Subsequently, the dried substrate precursor is coated with a second composition (3) comprising a hydrophilic polymer material (e.g. PVP) and a UV-crosslinker (Step B) which is then removed in a pattern as desired using e.g. UV exposure through a photomask (Step C), followed by rinsing with a suitable solvent (e.g. isopropanol where PVP is used) to reveal a pattern of the underlying hydrophobic and oleophilic first composition (2) (Step D).

According to a second method depicted schematically in FIG. 2, a substrate having hydrophilic vs. hydrophobic and oleophilic wetting contrasts is prepared by coating a substrate precursor (1) (e.g. a polyimide (PI), polyethylene terephthalate (PET), polyethylene naphthalate (PEN), polycarbonate (PC), polynorbornene (PNB) or polyethersulfone (PES) sheet coated with a hydrophilic layer (1a) comprising regenerated celluloses, polyvinyl alcohol, polyvinylphenol (PVP) or polyvinylpyrrolidone with e.g. a thickness of 100-150 μm and A4 (210×297 mm dimensions) with a first composition (2) comprising a polymer (e.g. polymethylmethacrylate (PMMA)), particles (e.g. SiO₂ nanoparticles of average particle size 10-20 nm), a UV-crosslinker and a solvent (e.g. butylacetate) (Step A). The particles may for example be present in the first composition (2) in an amount of 50 vol. % relative to the total amount of polymer and inorganic particles. For example, a 1 μm thick layer of the first composition (2) could be applied to the substrate precursor by spin-coating or doctor-blading. The coated substrate precursor is then left to dry, forming a hydrophobic and oleophilic surface.

Subsequently, the first composition (2) is removed from part of the dried substrate precursor by UV exposure through a photomask (Step B), followed by rinsing with a suitable solvent (e.g. butylacetate where PMMA is used as the polymer matrix material) (Step C) to reveal a pattern of the underlying hydrophilic coating on the substrate precursor.

According to a third method depicted schematically in FIG. 3, a substrate having hydrophilic vs. hydrophobic and oleophilic wetting contrast is prepared by coating a substrate precursor (1) (e.g. a polyimide (PI), polyethylene terephthalate (PET), polyethylene naphthalate (PEN), polycarbonate (PC), polynorbornene (PNB) or polyethersulfone (PES) sheet with e.g. a thickness of 100-150 μm and A4 (210×297 mm) dimensions) with a first composition (2) comprising a polymer (e.g. polymethylmethacrylate (PMMA)), particles (e.g. SiO₂ nanoparticles of average particle size 10-20 nm) and a solvent (e.g. butylacetate) (Step A). The particles may for example be present in the first composition (2) in an amount of 50 vol. % relative to the total amount of polymer and inorganic particles. For example, a 1 μm thick layer of the first composition (2) could be applied to the substrate precursor by spin-coating or doctor-blading. The coated substrate precursor is then left to dry, forming a hydrophobic and oleophilic surface.

Subsequently, the substrate precursor is coated with an acid-soluble polymer (4) (e.g. poly(4-vinylpyridine) (Step B). Subsequently, a capping layer of a non-acid-soluble hydrophilic polymer (5) (e.g. polyvinylphenol (PVP)) is coated on the acid-soluble polymer (Step C). The acid-soluble polymer (4) and the non-acid-soluble hydrophilic polymer (5) are selected so that the glass transition temperature of the non-acid-soluble hydrophilic polymer (5) is lower than that of the acid-soluble polymer (4), and both are below the glass transition temperature of the layer of the first composition (2). Then, micro-embossing is effected for a temperature ramp increasing from the glass transition temperature of the hydrophilic capping layer (5) to the glass transition temperature of the acid-soluble layer (4) while remaining below the glass transition temperature of the first composition (2) (Step D). This results in the formation of embossed areas where the composite layer is covered by a thin intermixed layer comprised mainly of the acid-soluble polymer (4). Subsequently, the thin intermixed layer at the bottom of the embossed area is rendered soluble by a short exposure to acid (e.g. by exposure to concentrated acetic acid vapours) (Step E). Then the solubilised intermixed layer is removed by washing with an appropriate solvent (e.g. water) (Step F).

The substrates produced by the methods of the present invention have good wetting contrasts formed between one area derived from a surface of the substrate having a roughened surface due to the coating of the precursor with the polymer comprising the particles in that area. Furthermore, these methods allow the production of substrates which are flexible and can therefore be used in reel-to-reel processing. A further advantage of these methods is that no plasma treatment is necessary so that relatively cheap and efficient large-scale production can be achieved. Furthermore, the methods of the present invention, and in particular the first and second methods, allow the manufacture of a substrate using very few processing steps; this is highly desirable.

Chemical Treatments

According to the present invention, substrates may be subjected to various chemical treatments in order to increase the difference in hydrophilicity and/or oleophilicity between the adjacent areas which make up the wetting contrast relative to the substrate prior to chemical treatment. This is especially desirable where one of the adjacent areas of the substrate is an inorganic oxide surface and the other is a polymer surface, because various methods are known which allow such wetting contrasts to be increased dramatically. Accordingly, these chemical treatment steps are described mainly in the context of improving such wetting contrasts, and not in the context of increasing the wetting contrast where both of the adjacent areas are polymer materials.

Whilst many types of chemical treatment could in principle be used to modify the substrates or to increase the difference in hydrophilicity and/or oleophilicity, only the following three types of treatment are discussed in detail herein; other chemical treatment methods which can be used in the present invention will be apparent to those skilled in the art. The three types of treatment discussed herein are: (i) fluorination treatment, (ii) oxidation treatment and (iii) fluoroalkylsilane treatment.

(i) Fluorination Treatment

Fluorination of a surface is achieved by chemical treatment, for example with SF₆ or CF₄ plasma.

Treatment by exposure of a surface to CF₄ plasma fluorinates even relatively unreactive moieties on that surface. Thus, for example, where an alkyl moiety is present on the surface, it will become fluorinated. As fluorocarbon moieties are hydrophobic and oleophobic, fluorination of common polymer materials such as polymethylmethacrylate (PMMA), polyimide (PI) and polyethylene terephthalate (PET) will render them hydrophobic and oleophobic.

In contrast, fluorination of an inorganic surface will result in the formation of the corresponding inorganic fluorides, which are generally reactive towards nucleophiles such as water molecules and form a hydrophilic hydroxyl-terminated surface upon exposure to water. For example, fluorination of SiO₂ results in the formation of Si—F bonds. Si—F bonds are relatively unstable, and are converted to Si—OH groups when exposed to moist air or water.

Where a polymer matrix comprising an inorganic material, e.g. in the form of particles, is exposed to CF₄ plasma, the concentration of inorganic particles at the surface is important in determining whether the surface is rendered hydrophilic or hydrophobic and oleophobic. A large concentration of inorganic particles at the surface will make the material behave more like the inorganic oxide and less like the matrix material, yielding a hydrophilic surface on fluorination. In contrast, where only a low surface concentration of the inorganic particles is present, the material will act more like the matrix polymer and will yield a hydrophobic and oleophobic surface upon fluorination. Prolonged exposure of a low concentration matrix of inorganic particles to CF₄ plasma will tend to make the surface more hydrophilic, as the matrix material becomes etched away by the plasma revealing a greater surface area of the inorganic particles. Treatment of hydroxylated groups with CF₄ plasma effectively replaces the —OH moieties with —F moieties, probably by etching away the surface layer containing the OH-bonds and providing a newly formed surface which is F-terminated. Whilst CF₄ plasma treatment is often used in laboratory scale production of wetting contrasts on inorganic substrates, it is preferable not to use such steps in commercial manufacture of these as a vacuum chamber is required to carry out plasma treatment. This is generally not practical in a factory setting, and adds expenditure.

(ii) Oxidation Treatment

Oxidation of a surface is achieved by chemical treatment, for example with O₂ plasma, ozone/UV or by corona discharge treatment in air.

Treatment by exposure of a surface to O₂ plasma oxidises even relatively unreactive moieties on that surface. Thus, for example, where an alkyl moiety is present on the surface, it will become oxidised, forming hydroxyl, carbonyl, and carboxylic acid groups. As hydroxyl and carboxylic acid moieties are hydrophilic, oxidation of common polymer materials such as polymethylmethacrylate (PMMA), polyimide (PI), and polyethylene terephthalate (PET), will render them hydrophilic.

Exposure of an inorganic material to O₂ plasma similarly introduces hydrophilic hydroxyl groups after exposure to atmospheric moisture or water.

Thus, oxidation treatment, e.g. by exposure to O₂ plasma, renders both inorganic materials and polymers hydrophilic. It follows that also exposure to a surface comprising inorganic particles and a matrix polymer results in a hydrophilic surface, regardless of the surface concentration of the inorganic material. Whilst O₂ plasma treatment is often used in laboratory scale production of wetting contrasts, it is preferable not to use such steps in commercial manufacture of these as a vacuum chamber is required to carry out plasma treatment. This is generally not practical in a factory setting, and adds expenditure. Alternatives include UV-ozone or corona (electrical discharge) treatments.

(iii) Fluoroalkylsilane Treatment

Treatment of a surface, for example by exposure to a material such as (heptadecafluorodecyl)-trichlorosilane (CF₃(CF₂)₇CH₂CH₂SiCl₃) in hexane results in the grafting of fluoroalkylsilane molecules onto reactive moieties on the surface such as hydroxyl groups. Thus fluoroalkylsilane molecules become grafted to the surface oxygen atoms of an inorganic oxide surface treated with e.g. (heptadecafluorodecyl)-trichlorosilane (CF₃(CF₂)₇CH₂CH₂SiCl₃) in hexane. This renders the surface super-hydrophobic and oleophobic.

Exposure of a pristine polymer to a fluoroalkylsilane treatment has no effect, as C—H bonds are not reactive towards trichlorosilanes under the reaction conditions usually applied for silanisations. It is possible to graft fluoroalkylsilanes to an oxidised polymer that contains hydroxyl moieties, for example a polymer oxidised by exposure to O₂ plasma. However, the C—O—Si bonds which are formed are easily cleaved by hydrolysis or reaction with other nucleophiles. For this reason, a fluoroalkylsilane treatment is generally not used to render polymer surfaces hydrophobic and oleophobic and their use is in practice restricted to the modification of inorganic oxide substrates.

The effect of silanisation with a fluoroalkylsilane of a polymer matrix comprising inorganic particles depends on the concentration of inorganic hydroxyl groups at the surface. Where the concentration is high, the surface is rendered super-hydrophobic and oleophobic. The less inorganic hydroxyl groups there are present at the surface, the less this is observed.

Methods of Producing Microelectronic Components

The most important use of the substrates obtainable by the methods of the present invention and the substrates of the present invention is in the production of microelectronic components by ink-jet printing or otherwise depositing electronically functional inks onto the substrates. In particular, microelectronic components such as thin-film transistors and light-emitting diodes can be produced by appropriate sequential deposition of electronically functional ink onto the substrates, the wetting contrasts helping to direct the electronically functional inks onto appropriate areas of the substrate. In these processes, it is not necessarily the case that all of the elements which make up the microelectronic component are ink-jet printed. It may be the case that some or all of the elements are deposited by other means. However, it is most preferable to use ink-jet printing to deposit all of the elements making up the microelectronic component on the substrate. It is particularly preferable to deposit any semiconductor layers using ink-jet printing.

For example, the substrates of the present invention could be used to produce a thin-film transistor by ink-jet printing (or otherwise depositing) a conductor solution onto the substrate to form source and drain electrodes, making use of the wetting contrasts to deposit the electrodes accurately. After the conductor ink has dried to form the electrodes, a solution comprising a semiconductor is deposited (e.g. by ink-jet printing) onto the substrate with the electrodes and left to dry. An insulator material is. then deposited onto the dried semiconductor material (e.g. by ink-jet printing) Once the insulator material is dry, a gate electrode is formed on the insulator material in appropriate alignment with the source and drain electrodes, thus completing the formation of the thin-film transistor.

The substrates of the present invention can also be used to produce for example a light-emitting diode. This is achieved by firstly ink-jet printing or otherwise depositing a semiconductor material onto a substrate on which an electrode has already been formed (e.g. by ink-jet printing a conductor solution onto the substrate), again making use of the wetting contrast, and leaving the deposited ink to dry to form a charge injection layer. Once the charge injection layer is dry, an emissive semiconductor material is deposited onto the charge injection layer (e.g. by ink-jet printing). Once this is dry, a cathode is formed on the emissive semiconductor material.

### EXAMPLES

The following experimental work was carried out by the present inventors, and supports their findings that substrates comprising wetting, contrasts associated with substrates having a surface comprising a polymer matrix comprising particles of a material other than the polymer matrix at their surfaces are advantageous in that wetting contrast comprising adjacent surface areas differing greatly in hydrophilicity and/or oleophilicity can be achieved.

### Example 1

### Modification of Surface Properties by Plasma Treatment

Preparation of Substrates

Reference Substrate

A 3% polymethylmethacrylate (PMMA) solution in butylacetate was prepared by dissolving 0.93 g of PMMA (from Sigma Aldrich) in 30 ml butylacetate. 0.5 ml of the solution was spin coated onto a glass substrate (12×12 mm) precursor (7059 from Corning) for 30 seconds at 1500 rpm in nitrogen. The coated precursor was then annealed for 20 minutes at 60° C. in nitrogen, followed by annealing for 20 minutes at 120° C. in nitrogen to form a Reference Substrate.

Substrate 1 (B1)

0.028 g of nanoparticulate SiO₂ (hexamethyldisilazane treated silica particles, 10-20 nm, from ABCR) was dispersed in 1 ml 6% PMMA in butylacetate (Aldrich) and 1 ml butylacetate (Aldrich). The mixture was mixed thoroughly by stirring on a magnetic stirrer and by a final ultrasonic mixing step in an ultrasonic bath for 5 minutes to yield a solution comprising 17.3 vol. % SiO₂. 0.5 ml of the solution was spin coated onto a glass substrate precursor (12×12 mm plate, 7059 from Corning) for 30 seconds at 1600 rpm in air. The coated precursor was then annealed for 20 minutes at 60° C. in nitrogen, followed by annealing for 20 minutes at 120° C. in nitrogen to form Substrate 1.

Substrate 2 (B2)

The procedure outlined above for substrate 1 was repeated, except that 0.056 g of SiO₂ was used. The solution thus obtained comprised 29.5 vol. % SiO₂. The solution was spin-coated onto a precursor as in Example 1, except that it was carried out at 2000 rpm.

Substrate 3 (B3)

The procedure outlined above for substrate 1 was repeated, except that 0.085 g of SiO₂ was used and that 1.5 ml of butylacetate was used rather than 1 ml. The solution thus obtained comprised 38.6 vol. % SiO₂. The solution was spin-coated onto a precursor as in Example 1, except that it was carried out at 2000 rpm.

Substrate 4 (B4)

The procedure outlined above for substrate 1 was repeated, except that 0.110 g of SiO₂ was used and that 2 ml of butylacetate was used rather than 1 ml. The solution thus obtained comprised 44.9 vol. % SiO₂. The solution was spin-coated onto a precursor as in Example 1, except that it was carried out at 2000 rpm.

Substrate 5 (B5)

The procedure outlined above for substrate 1 was repeated, except that 0.136 g of SiO₂ was used and that 2 ml of butylacetate was used rather than 1 ml. The solution thus obtained comprised 50.4 vol. % SiO₂. The solution was spin-coated onto a precursor as in Example 1, except that it was carried out at 2000 rpm.

Plasma Treatment and Measurements

Substrates 1-5 and the Reference Substrate were rinsed with water. Then the contact angles with water droplets of size 1-5 μl were measured for each of these six substrates using a goniometer (contact angle measuring device).

Subsequently, each of the six substrates was exposed to an O₂ plasma. treatment (in a Branson/IPC Series S2100 Plasma Stripper system equipment) for 7 seconds at a flow rate of 200 ml/min and at a power of 200 W. Contact angles of the treated substrates were measured using the same apparatus and methods as above.

Subsequently, each of the six oxidised substrates was exposed to CF₄ plasma in a Branson/IPC Series S2100 Plasma Stripper system for 7 seconds at a flow rate of 200 ml/min and at a power of 200 W. Then the substrates were rinsed with de-ionised water (Elix 10 DI water plant). Contact angles of the treated substrates were measured using the same apparatus and methods as above.

Finally, the film thickness of each of the six substrates was measured using a Dektak 8 stylus profiler technique.

The resulting data is set out in table 2 below:

TABLE 2

| | Ref. | B1 | B2 | B3 | B4 | B5 |
|---|---|---|---|---|---|---|
| Vol. % (SiO₂) in solid film | 0 | 17.3 | 29.5 | 38.6 | 44.9 | 50.4 |
| Spin-coating speed (rpm) | 1500 | 1600 | 2000 | 2000 | 2000 | 2000 |
| I. Initial contact angle after | 74° | 82 | 92° | 100° | 117° | 125° |
| water-rinse | | | | | | |
| II. Contact angle after (5 + 2)s | 7° | 15° | 5° | 5° | 5° | 5° |
| O₂-plasma; flow-rate O₂ 200 ml/min, | | | | | | |
| power 200 W | | | | | | |
| III. Contact angle after (5 + 2)s | 76° | 90° | 53° | 10° | 5° | 5° |
| CF₄-plasma; flow-rate CF₄ 200 ml/ | | | | | | |
| min, power 200 W; measured after | | | | | | |
| water-rinse | | | | | | |
| Final film thickness (nm) | 436 | 530 | 150 | 500 | 350 | 680 |

### Example 2

### Modification of Surface Properties by Silanisation with a Fluoroalkylsilane

Preparation of Substrates

A Reference Substrate and Substrates 1-5 were prepared as in Example 1 above.

Plasma Treatment and Measurements

Substrates 1-5 and the Reference Substrate were rinsed with water. Then the contact angles with water droplets of size 1-5 μl were measured for each of these six substrates using a goniometer (contact angle measuring device).

Subsequently, each of the six substrates was exposed to a CF₄ plasma treatment in a Branson/IPC Series S2100 Plasma Stripper system for 7 seconds at a flow rate of 200 ml/min and at a power of 200 W. Contact angles of the treated substrates were measured using the same apparatus and methods as above. In case of the substrates with high oxide content (B4 and B5), the inventors observed a fast initial decrease of the contact angles, with the values slowly stabilising after prolonged measurement times. Thus, the contact angle ranges reported in table 3 below for the high oxide content samples correspond to the initial values and the values obtained after 5 minutes measuring time.

Subsequently, each of the six fluorinated substrates were exposed to another CF₄ plasma treatment in a Branson/IPC Series S2100 Plasma Stripper system for 7 seconds at a flow rate of 200 ml/min and at a power of 200 W. Contact angles of the treated substrates were measure using the same apparatus and methods as above. Again, an initial decrease of the contact angles was observed for the samples B4 and B5, with the values slowly stabilising after prolonged measurement times. However, due to the higher initial reaction rate after the second CF₄ plasma treatment, the initial contact angle values could not be determined accurately. Therefore, only the contact angles determined after 5 minutes measuring time are reported in table 3 below.

Subsequently, each of the six substrates was rinsed with de-ionised water (Elix 10 DI water plant) and the contact angles with water were measured again.

Finally, the rinsed substrates were treated with (heptadecafluorodecyl)-trichlorosilane (CF₃(CF₂)₇CH₂CH₂SiCl₃) in an octane solvent. The substrates were blown dry with nitrogen gas and then their contact angles with water were measured again.

The resulting data is set out in table 3 below:

TABLE 3

| | Ref. | B1 | B2 | B3 | B4 | B5 |
|---|---|---|---|---|---|---|
| Vol. % (SiO₂) in | 0 | 17.3 | 29.5 | 38.6 | 44.9 | 50.4 |
| film | | | | | | |
| Contact angle | 75° | 91° | 93° | 118° | 133° | 133° |
| initial | | | | | | |
| (5 + 2)s 200 | 105° | 110 | 116° | 95° | 85° | 85° |
| ml/min CF₄/200 W | | | | | to | to |
| | | | | | 50° | 55° |
| (5 + 2)s 200 | 101° | 110° | 118° | 89° | 45° | 40° |
| ml/min CF₄/200 W | | | | | | |
| Rinsing with water | 100° | 92° | 90° | 57° | 27° | 30° |
| Fluoro-SAM in | | 110° | 127° | 145° | 140° | 145° |
| octane | | | | | | |

Data Analysis

From the above data, it can be seen that it is possible to create highly hydrophilic and highly hydrophobic surfaces on a substrate having a surface layer comprising particles which are embedded in a polymer matrix. Thus it is possible to manufacture substrates comprising good wetting contrasts by carrying out the methods 1-3 described above, as well as by other methods known to the person skilled in the art, all of which make use of substrates having a surface layer comprising particles which are embedded in a polymer matrix.

Best Mode

The best mode of the present invention is to prepare the substrate using the third method of the present invention as described above. This method allows the production of a flexible substrate without the need for surface fluorination, the substrate having a good wetting contrast between the hydrophilic and hydrophobic/oleophilic areas of the surface layer of the substrate wherein the difference in hydrophilicity between these areas is greater than that which is achievable in the prior art (when avoiding fluorinated surfaces) because of the surface roughening caused in the hydrophobic area as a result of the presence of the particles on and/or immediately under the surface of the substrate.

Furthermore, the third method can be performed using a flexible substrate base, which makes it the end substrates useful in reel-to-reel processing.

Preferably, the third method is carried out in the following manner:

A substrate having hydrophilic vs. hydrophobic and oleophilic wetting contrast is prepared by coating a substrate precursor (1) (e.g. a polyimide (PI), polyethylene terephthalate (PET), polyethylene naphthalate (PEN), polycarbonate (PC), polynorbornene (PNB) or polyethersulfone (PES) sheet with e.g. a thickness of 100-150 μm and A4 (210×297 mm) dimensions) with a first composition (2) comprising a polymer (e.g. polymethylmethacrylate (PMMA)) and particles (e.g. SiO₂ nanoparticles of average particle size 10-20 nm) and a solvent (e.g. butylacetate) (Step A). The particles may for example be present in the first composition (2) in an amount of 50 vol. % relative to the total amount of polymer and inorganic particles. For example, a 1 μm thick layer of the first composition (2) could be applied to the substrate precursor by spin-coating or doctor-blading. The coated substrate precursor is then left to dry, forming a hydrophobic and oleophilic surface.

Subsequently, the substrate precursor is coated with an acid-soluble polymer (4) (e.g. poly(4-vinylpyridine) (PVPy) (Step B). Subsequently, a capping layer of a non-acid-soluble hydrophilic polymer (5) (e.g. polyvinylphenol (PVP)) is coated on the acid-soluble polymer (Step C). The acid-soluble polymer (4) and the non-acid-soluble hydrophilic polymer (5) are selected so that the glass transition temperature of the non-acid-soluble hydrophilic polymer (5) is lower than that of the acid-soluble polymer (4), and both are below the glass transition temperature of the layer of the first composition (2). Then, micro-embossing is effected for a temperature ramp increasing from the glass transition temperature of the hydrophilic capping layer (5) to the glass transition temperature of the acid-soluble layer (4) while remaining below the glass transition temperature of the first composition (2) (Step D) . This results in the formation of embossed areas where the composite layer is covered by a thin intermixed layer comprised mainly of the acid-soluble polymer (4). Subsequently, the thin intermixed layer at the bottom of the embossed area is rendered soluble by a short exposure to acid (e.g. by exposure to concentrated acetic acid vapours) (Step E). Then the solubilised intermixed layer is removed by washing with an appropriate solvent (e.g. water) (Step F).

1. A method of producing a substrate having a surface which comprises adjacent areas of different hydrophilicity and/or oleophilicity, the method comprising:
(ia) forming a pattern of a first composition comprising a polymer matrix and particles of a material other than the polymer matrix on a substrate precursor.

2. A method of producing a substrate having a surface which comprises adjacent areas of different hydrophilicity and/or oleophilicity, the method comprising:
(ib) coating a substrate precursor with a first composition comprising a polymer matrix and particles of a material other than the polymer matrix on a substrate precursor; and
(ic) forming on the first composition a pattern of a second composition comprising a polymer, the second composition having a different hydrophilicity and/or oleophilcity to the first composition.

3. A method according to claim 1, wherein the particles in the first composition are inorganic oxide particles.

4. A method according to claim 3, wherein the inorganic oxide is one or more of silicon dioxide, indium tin oxide, aluminium oxide, titanium dioxide, tin oxide, tantalum pentoxide, a perovskite or a zeolite.

5. A method according to claim 1, wherein the particles in the first composition are organic particles comprising organic molecules having a molecular weigth in the range 200-1000 daltons.

6. A method according to claim 1, wherein the particles have an average particle size of less than 0.2 mm.

7. A method according to claim 1, wherein the substrate precursor is an inorganic oxide plate.

8. A method according to claim 1, wherein the substrate precursor is a polymer foil.

9. A method according to claim 1, wherein the difference in hydrophilicity and/or oleophilicity between the adjacent areas is such that these areas differ in their contact angles with hexane by 60° or more and/or with water by 80° or more.

10. A method according to claim 1, wherein one of the adjacent areas of the substrate comprises an inorganic oxide at the surface.

11. A method of producing a modified substrate having a surface which comprises adjacent areas of different hydrophilicity and/or oleophilicity, the method comprising the steps of:
(i) producing a substrate by a method as defined in claim 10; and
(ii) chemically treating the substrate surface to form the modified substrate, the adjacent surface areas of the modified substrate having a greater difference in hydrophilicity and/or oleophilicity than the corresponding areas of the substrate prior to chemical treatment.

12. A method of producing a microelectronic component, comprising the steps of:
(i) producing a substrate or modified substrate having adjacent areas of different hydrophilicity and/or oleophilicity on the same surface by a method as defined in claim 1; and
(ii) depositing a first solution onto the substrate or modified substrate to form an area comprising a first electronically functional material.

13. A method according to claim 12, wherein the microelectronic component is a thin-film transistor and the first electronically functional material is a semiconductor material, and the method further comprises the steps of.
(iii) prior to step (ii), depositing a second solution onto the substrate or modified substrate to form source and drain electrodes so that these underlie the area formed in step (ii);
(iv) depositing a third solution onto the semiconductor material to form an insulating layer; and
(v) forming a gate electrode on the insulator material in appropriate alignment with the source and drain electrodes.

14. A method according to claim 12, wherein the microelectric component is a light emitting diode, and the first electronically functional material is a semiconductor material which constitutes a charge injection layer, and the substrate or modified substrate comprises an anode, the method further comprising the steps of:
(iii) depositing a fourth solution onto the first semiconductor material to form an area comprising a second emissive semiconductor material; and
(iv) forming a cathode on the second semiconductor material.

15. A method according to claim 12, wherein the deposition of the solutions is carried out by ink-jet printing.

16. A substrate having adjacent areas of hydrophilicity and/or oleophilicity on the same surface, one of the adjacent areas corresponding to an area comprising a surface layer comprising particles in a polymer matrix.

17. A substrate produced by the method according to claim 1, wherein the substrate is a polymer substrate.

18. (canceled)
